(19) United States
(12) Patent Application Publication
(10) Pub. No.: US 2026/0088544 A1
(43) Pub. Date: Mar. 26, 2026

(54) ELECTRICAL CONNECTOR

(71) Applicant: CHENG UEI PRECISION INDUSTRY CO., LTD., New Taipei City (TW)

(72) Inventors: CHAO YE, Dong-Guan City (CN); JUN CHEN, Dong-Guan City (CN)

(21) Appl. No.: 19/171,192

(22) Filed: Apr. 4, 2025

(30) Foreign Application Priority Data
Sep. 25, 2024 (CN) 202422348387.1

(51) Int. Cl. H01R 13/05; H01R 13/443; H01R 13/506

(52) U.S. Cl. CPC H01R 13/055; H01R 13/443; H01R 13/506

(57) ABSTRACT

An electrical connector includes an insulating base, a terminal assembly and a plurality of insulating dummy terminals. The terminal assembly is mounted in the insulating base. The terminal assembly has a plurality of connecting terminals, a first spacing and a second spacing. The plurality of the connecting terminals are arranged in two rows. The first spacing and the second spacing are formed at an outer side of each row of the connecting terminals. The first spacing and the second spacing are abreast disposed along a transverse direction. A width of the first spacing is wider than a width of the second spacing. The plurality of the insulating dummy terminals are disposed in the first spacing. Rear ends of each two adjacent insulating dummy terminals extend rearward and then are merged with each other to form a collecting portion extending rearward.

### CROSS REFERENCE TO RELATED APPLICATIONS

The present application is based on, and claims priority from, China Patent Application No. 202422348387.1, filed Sep. 25, 2024, the disclosure of which is hereby incorporated by reference herein in its entirety.

### BACKGROUND OF THE INVENTION

### Field of the Invention

The present invention generally relates to a connector, and more particularly to an electrical connector with a structure that reduces a corrosion production when sweat infiltrates into the electrical connector.

### Description of Related Art

Referring to FIG. 10 to FIG. 12, a perspective view of a tongue assembly 10′ of an electrical connector is shown in FIG. 10. The electrical connector is a USB (Universal Serial Bus) Type-C female connector. The tongue assembly 10′ includes an insulating base 70′ and a terminal assembly 20′ fixed inside the insulating base 70′. The terminal assembly 20′ includes a plurality of terminals 21′. The plurality of the terminals 21′ are fixed in the insulating base 70′. The terminal assembly 20′ is without full pins. A left side and a right side of the insulating base 70′ are defined as two outer sides. Each outer side of the insulating base 70′ has two adjacent terminals 21′. The two outer sides of the insulating base 70′ have two larger spaces s21′, respectively. The two adjacent terminals 21′ disposed to one outer side of the insulating base 70′ are spaced from each other to form one larger space s21′between the two adjacent terminals 21′. The other two adjacent terminals 21′ disposed to the other outer side of the insulating base 70′ are spaced from each other to form the other larger space s21′ between the other two adjacent terminals 21′. The insulating base 70′ extends in the two larger spaces s21′ to form a flat surface between the two adjacent terminals 21′.

After sweat infiltrates into the electrical connector, a flow range of the sweat is roughly at a front end of the tongue assembly 10′, that is to say, the flow range of the sweat is roughly in an area where the plurality of the terminals 21′ are exposed to the insulating base 70′. A surface of each larger space s21′ is too flat, so that a path crl′ along an insulating surface between the two adjacent terminals 21′ of each outer side of the insulating base 70′ is short, and a creepage distance is small. In that case, when the two adjacent terminals 21′ of each outer side of the insulating base 70′ are provided electric current, a stronger electric field is formed between the two adjacent terminals 21′ of each outer side of the insulating base 70′ , and a stronger driving force for electrochemical reactions is provided, consequently, a corrosion phenomenon occurrence is facilitated, and more corrosive substances are caused to be accumulated on a surface of the front end of the tongue assembly 10′. As a result, the electrical connector is corroded and a damage of the electrical connector is caused.

Therefore, it is necessary to provide an electrical connector with a structure that reduces a corrosion production when sweat infiltrates into the electrical connector.

### BRIEF SUMMARY OF THE INVENTION

An object of the present invention is to provide an electrical connector with a structure that reduces a corrosion production when sweat infiltrates into the electrical connector. The electrical connector includes an insulating base, a terminal assembly and a plurality of insulating dummy terminals. The terminal assembly is mounted in the insulating base. The terminal assembly has a plurality of connecting terminals, a first spacing and a second spacing. The plurality of the connecting terminals are fixed in the insulating base. The plurality of the connecting terminals are arranged in two rows. Each row of the connecting terminals is arranged along a transverse direction. The two rows of the connecting terminals are arranged along an up-down direction. The first spacing and the second spacing are formed at an outer side of each row of the connecting terminals. The first spacing and the second spacing are abreast disposed along the transverse direction. A width of the first spacing is wider than a width of the second spacing. The plurality of the insulating dummy terminals are spaced from one another. The plurality of the insulating dummy terminals are disposed in the first spacing. Rear ends of each two adjacent insulating dummy terminals extend rearward and then are merged with each other to form a collecting portion extending rearward. Each two adjacent insulating dummy terminals and the collecting portion which is connected to the rear ends of the two adjacent insulating dummy terminals are shown as an inverted Y shape. Docking surfaces of the plurality of the insulating dummy terminals and docking surfaces of the plurality of the connecting terminals are coplanar.

Another object of the present invention is to provide an electrical connector. The electrical connector includes an insulating base, a terminal assembly and a plurality of insulating dummy terminals. The terminal assembly is mounted in the insulating base. The terminal assembly has a plurality of connecting terminals, a first spacing and a second spacing. The plurality of the connecting terminals are fixed in the insulating base. The plurality of the connecting terminals are arranged in two rows. Each row of the connecting terminals is arranged along a transverse direction. The two rows of the connecting terminals are arranged along an up-down direction. The first spacing and the second spacing are formed at an outer side of each row of the connecting terminals. The first spacing and the second spacing are abreast disposed along the transverse direction. A width of the first spacing is wider than a width of the second spacing. The plurality of the insulating dummy terminals are disposed at terminal missing positions. The plurality of the insulating dummy terminals are disposed in the first spacing. Rear ends of each two adjacent insulating dummy terminals extend rearward and then are merged with each other to form a collecting portion extending rearward. An interval between an outer insulating dummy terminal of each two adjacent insulating dummy terminals and the connecting terminal which is closest to the outer insulating dummy terminal of the two adjacent insulating dummy terminals is the same as an interval between an inner insulating dummy terminal of each two adjacent insulating dummy terminals and the connecting terminal which is closest to the inner insulating dummy terminal of the two adjacent insulating dummy terminals. Docking surfaces of the plurality of the insulating dummy terminals and docking surfaces of the plurality of the connecting terminals are coplanar.

Another object of the present invention is to provide an electrical connector. The electrical connector includes an insulating base, a terminal assembly and a plurality of insulating dummy terminals. The terminal assembly is mounted in the insulating base. The terminal assembly has a plurality of connecting terminals, a first spacing and a second spacing. The plurality of the connecting terminals are fixed in the insulating base. The plurality of the connecting terminals are arranged in two rows. Each row of the connecting terminals is arranged along a transverse direction. The two rows of the connecting terminals are arranged along an up-down direction. The first spacing and the second spacing are formed at an outer side of each row of the connecting terminals. The first spacing is formed between the outermost connecting terminal and the middle connecting terminal of each outer side of each row of the connecting terminals. The second spacing is formed between the middle connecting terminal and the innermost connecting terminal of each outer side of each row of the connecting terminals. The first spacing and the second spacing are abreast disposed along the transverse direction. A width of the first spacing is wider than a width of the second spacing. The plurality of the insulating dummy terminals are protruded from a surface of the insulating base. The plurality of the insulating dummy terminals are disposed in the first spacing. Rear ends of each two adjacent insulating dummy terminals extend rearward and then are merged with each other to form a collecting portion extending rearward. Docking surfaces of the plurality of the insulating dummy terminals and docking surfaces of the plurality of the connecting terminals are coplanar.

As described above, the electrical connector disposes the plurality of the insulating dummy terminals at the terminal missing positions of the tongue assembly, corrosions caused by the electrochemical reactions are reduced when sweat infiltrates into the electrical connector. Furthermore, the plurality of the insulating dummy terminals are protruded from the surface of the insulating base, and dimensions of the plurality of the insulating dummy terminals are approximately the same as dimensions of the plurality of the connecting terminals. In addition, the interval between the outer insulating dummy terminal of each two adjacent insulating dummy terminals and the connecting terminal which is closest to the outer insulating dummy terminal of the two adjacent insulating dummy terminals is the same as the interval between the inner insulating dummy terminal of each two adjacent insulating dummy terminals and the connecting terminal which is closest to the inner insulating dummy terminal of the two adjacent insulating dummy terminals, so the insulating dummy terminals disposed in the first spacing elongate a path, and when the two adjacent connecting terminals located to two sides of each first spacing are powered on, an electric field intensity between the two adjacent connecting terminals is reduced. As a result, the electrical connector has a structure that reduces a corrosion production when the sweat infiltrates into the electrical connector, and a corrosion resistance performance of the electrical connector is ultimately improved.

### BRIEF DESCRIPTION OF THE DRAWINGS

The present invention will be apparent to those skilled in the art by reading the following description, with reference to the attached drawings, in which:

FIG. 1 is an exploded view of an electrical connector according to the present invention;

FIG. 2 is a perspective view of the electrical connector according to the present invention;

FIG. 3 is a partially exploded view of a tongue assembly of the electrical connector according to the present invention;

FIG. 4 is an exploded view of the tongue assembly of the electrical connector according to the present invention;

FIG. 5 is a perspective view of the tongue assembly of the electrical connector according to the present invention;

FIG. 6 is an enlarged view of an encircled portion VI of the tongue assembly of the electrical connector according to the present invention of FIG. 5;

FIG. 7 is a schematic diagram of a pin configuration of a USB Type-C connector according to the present invention;

FIG. 8 is a top view of the tongue assembly of the electrical connector according to the present invention;

FIG. 9 is a partial cross-sectional view of the tongue assembly of the electrical connector along a line I-I of FIG. 8;

FIG. 10 is a perspective view of a tongue assembly of a conventional electrical connector in prior art;

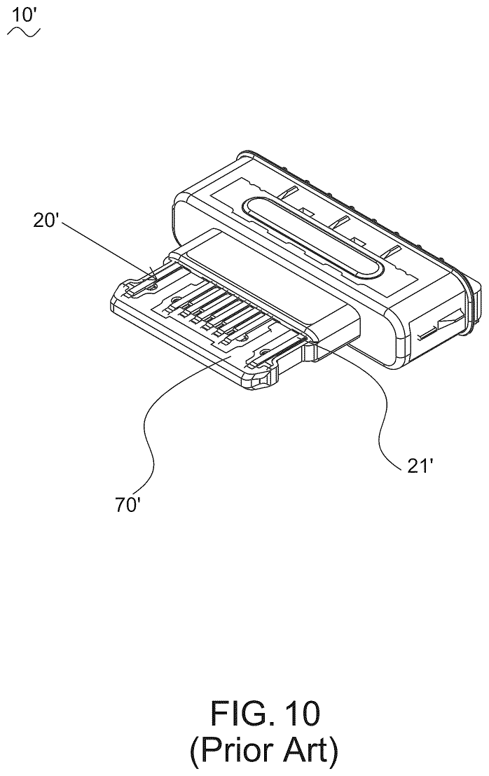

FIG. 11 is a top view of the tongue assembly of the conventional electrical connector of FIG. 10; and

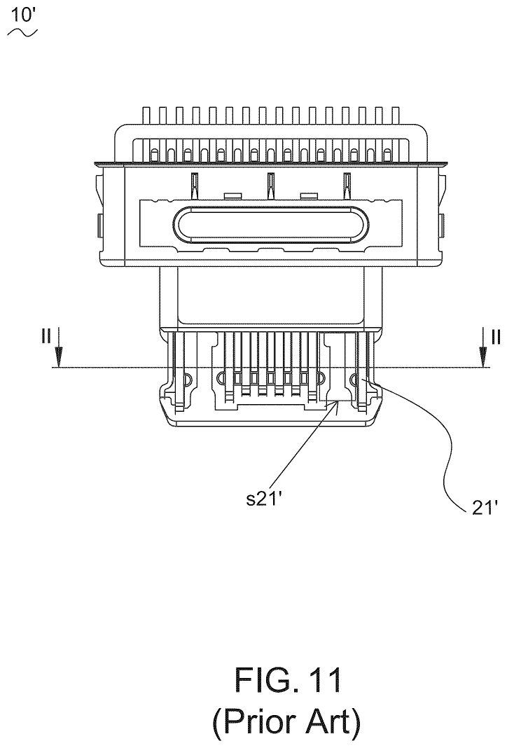

FIG. 12 is a partial cross-sectional view of the tongue assembly of the conventional electrical connector along a line II-II of FIG. 11.

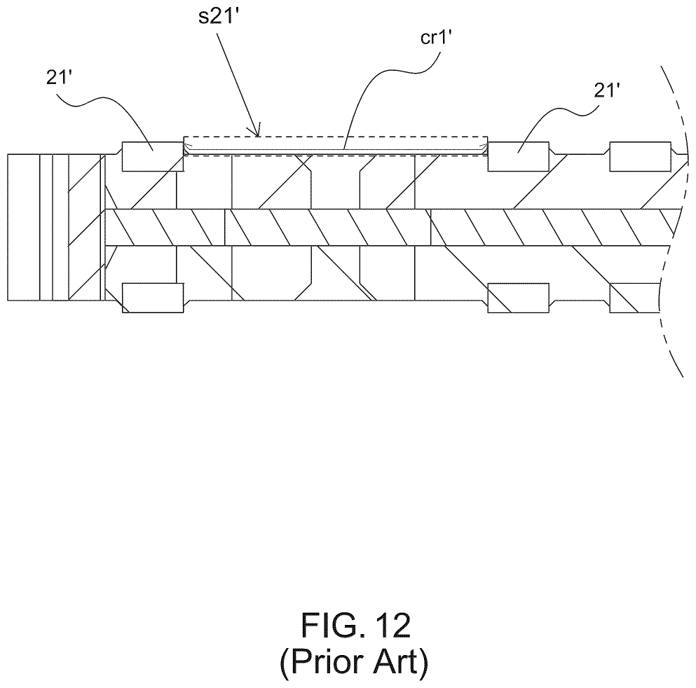

### DETAILED DESCRIPTION OF THE INVENTION

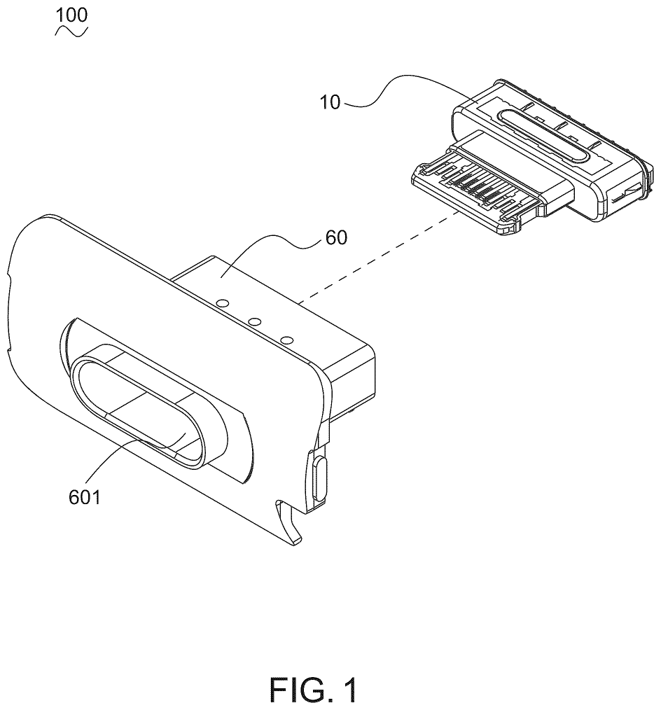

With reference to FIG. 1, in order to provide a detailed description of a technical content of an electrical connector 100 in accordance with the present invention, structural features of the electrical connector 100, objectives and effects achieved by the electrical connector 100 according to the present invention, the electrical connector 100 according to a following embodiment of the present invention is given in conjunction with drawings for a detailed illustration.

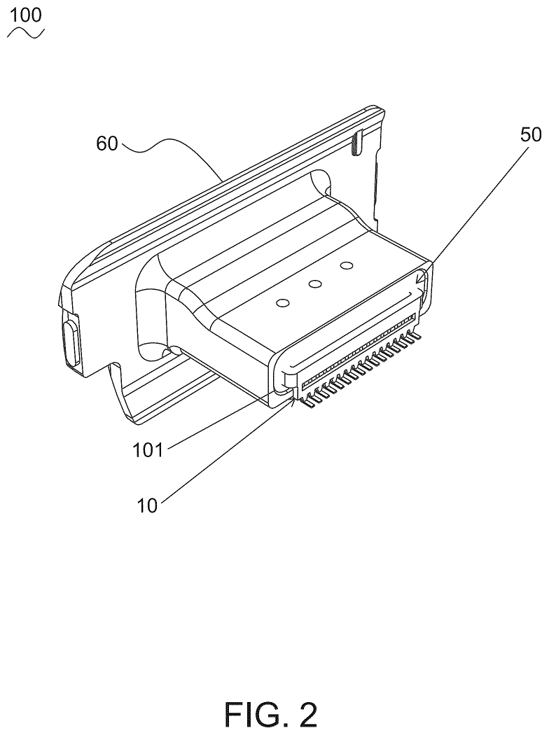

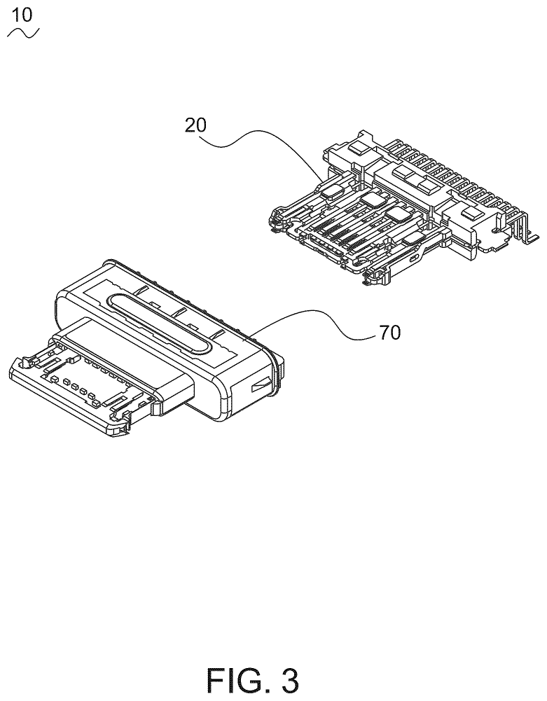

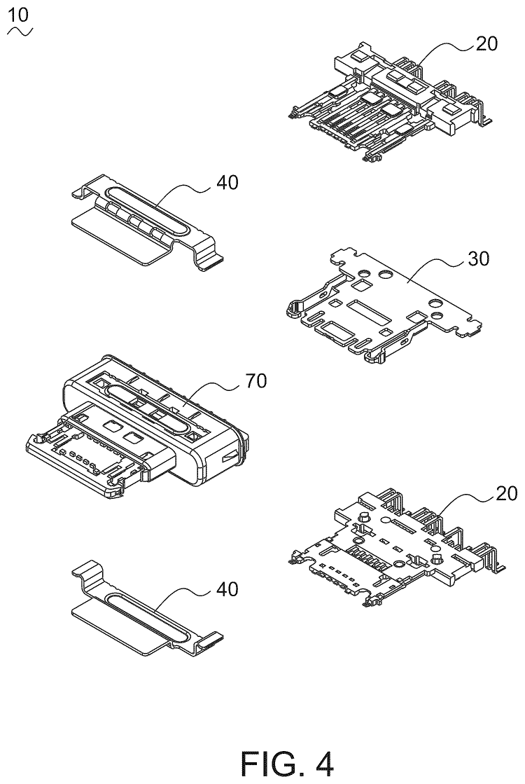

Referring to FIG. 1 to FIG. 4, the electrical connector 100 according to the present invention is shown. The electrical connector 100 is a USB (Universal Serial Bus) Type-C connector. The electrical connector 100 is a USB Type-C receptacle connector. The electrical connector 100 includes a shielding shell 60, a receiving space 601 formed in the shielding shell 60, a tongue assembly 10 disposed in the receiving space 601, and a colloid 50 coated to a rear end of the tongue assembly 10 to seal a gap 101 between the tongue assembly 10 and the shielding shell 60.

The tongue assembly 10 includes an insulating base 70 which is formed inside a mold, a terminal assembly 20 combined with the insulating base 70 by way of forming inside the mold, a middle plate 30 disposed in a middle of the terminal assembly 20, and two shielding pieces 40 respectively disposed at an upper portion and a lower portion of a rear end of the tongue assembly 10.

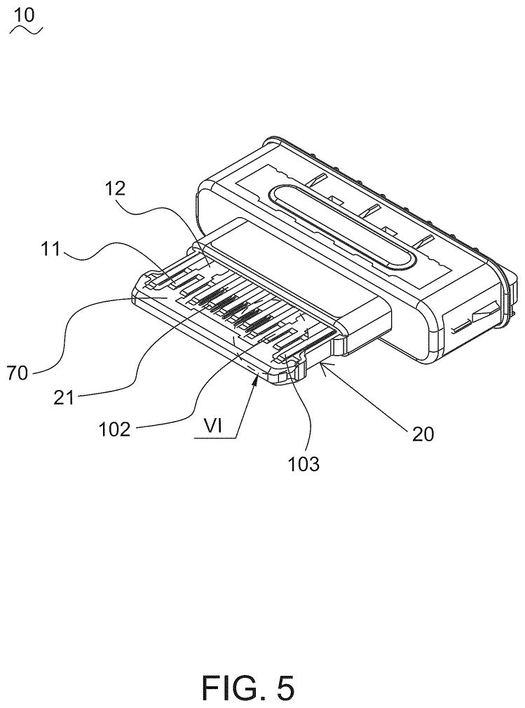

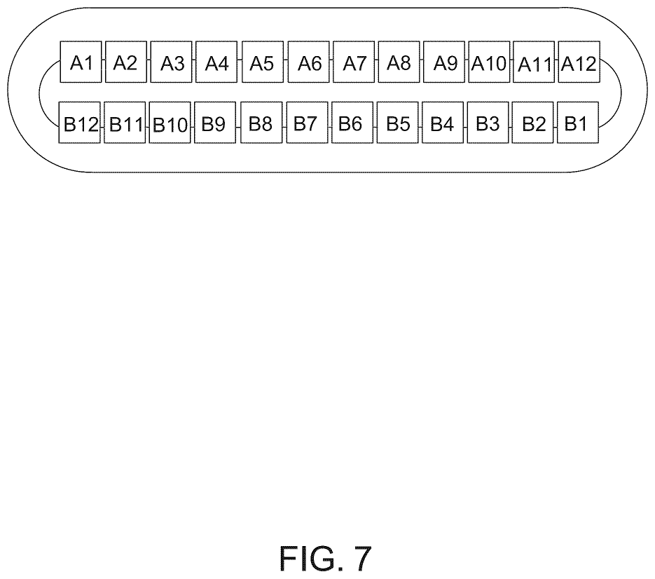

Referring to FIG. 5 to FIG. 7, a schematic diagram of a pin configuration of the USB Type-C connector is shown in FIG. 7. The terminal assembly 20 is mounted in the insulating base 70. In this embodiment, the terminal assembly 20 includes a plurality of connecting terminals 21, a first spacing s1, a second spacing s2, a third spacing s3 and a fourth spacing s4. The plurality of the connecting terminals 21 are fixed in the insulating base 70. The plurality of the connecting terminals 21 are spaced apart from each other. The plurality of the connecting terminals 21 are arranged in two rows. Each row of the connecting terminals 21 are arranged along a transverse direction. The two rows of the connecting terminals 21 are arranged along an up-down direction.

The plurality of the connecting terminals 21 are only disposed at a first pin position A1, a fourth pin position A4, a fifth pin position A5, a sixth pin position A6, a seventh pin position A7, an eighth pin position A8, a ninth pin position A9, a twelfth pin position A12, a first terminal position B1, a fourth terminal position B4, a fifth terminal position B5, a sixth terminal position B6, a seventh terminal position B7, an eighth terminal position B8, a ninth terminal position B9 and a twelfth terminal position B12. The connecting terminals 21 disposed at the first pin position A1, the fourth pin position A4, the fifth pin position A5, the sixth pin position A6, the seventh pin position A7, the eighth pin position A8, the ninth pin position A9 and the twelfth pin position A12 are arranged in the row which is located at an upper portion of the terminal assembly 20. The connecting terminals 21 disposed at the first terminal position B1, the fourth terminal position B4, the fifth terminal position B5, the sixth terminal position B6, the seventh terminal position B7, the eighth terminal position B8, the ninth terminal position B9 and the twelfth terminal position B12 are arranged in the row which is located at a lower portion of the terminal assembly 20.

A second pin position A2, a third pin position A3, a tenth pin position A10, an eleventh pin position A11, a second terminal position B2, a third terminal position B3, a tenth terminal position B10 and an eleventh terminal position B11 lack the connecting terminals 21, and the second pin position A2, the third pin position A3, the tenth pin position A10, the eleventh pin position A11, the second terminal position B2, the third terminal position B3, the tenth terminal position B10 and the eleventh terminal position B11 are used for high-speed signal transmission.

The insulating base 70 is further equipped with a plurality of insulating dummy terminals 11. The plurality of the insulating dummy terminals 11 are spaced from one another. The plurality of the insulating dummy terminals 11 are disposed at terminal missing positions of the tongue assembly 10 of the electrical connector 100 which are the second pin position A2, the third pin position A3, the tenth pin position A10, the eleventh pin position A11, the second terminal position B2, the third terminal position B3, the tenth terminal position B10 and the eleventh terminal position B11. The plurality of the insulating dummy terminals 11 are protruded from a surface of the insulating base 70. Top surfaces of the plurality of the insulating dummy terminals11 are defined as docking surfaces 102 of the plurality of the insulating dummy terminals 11, and top surfaces of the plurality of the connecting terminals 21 are defined as docking surfaces 103 of the plurality of the connecting terminals 21. The docking surfaces 102 of the plurality of the insulating dummy terminals 11 and the docking surfaces 103 of the plurality of the connecting terminals 21 are coplanar.

Rear ends of each two adjacent insulating dummy terminals 11 extend rearward and then are merged with each other to form a collecting portion 12 extending rearward. For example, the rear ends of the two adjacent insulating dummy terminals 11 which are disposed at the second pin position A2 and the third pin position A3 extend rearward and then are merged with each other to form the collecting portion 12 extending rearward. The rear ends of the two adjacent insulating dummy terminals 11 which are disposed at the tenth pin position A10 and the eleventh pin position A11 extend rearward and then are merged with each other to form the collecting portion 12 extending rearward. The rear ends of the two adjacent insulating dummy terminals 11 which are disposed at the second terminal position B2 and the third terminal position B3 extend rearward and then are merged with each other to form the collecting portion 12 extending rearward. The rear ends of the two adjacent insulating dummy terminals 11 which are disposed at the tenth terminal position B10 and the eleventh terminal position B11 extend rearward and then are merged with each other to form the collecting portion 12 extending rearward.

An appearance dimension of each insulating dummy terminal 11 is approximately the same as an appearance dimension of each connecting terminal 21. Mating surfaces of the plurality of the insulating dummy terminals 11 and mating surfaces of the plurality of the connecting terminals 21 are on the same plane, so when the plurality of the insulating dummy terminals 11 and the plurality of the connecting terminals 21 are docked with a docking connector (not shown), a problem is avoided being occurred. Each two insulating dummy terminals 11 and the collecting portion 12 which is connected to the rear ends of the two adjacent insulating dummy terminals 11 are protruded from the surface of the insulating base 70, and each two adjacent insulating dummy terminals 11 and the collecting portion 12 which is connected to the rear ends of the two adjacent insulating dummy terminals 11 are shown as an inverted Y shape.

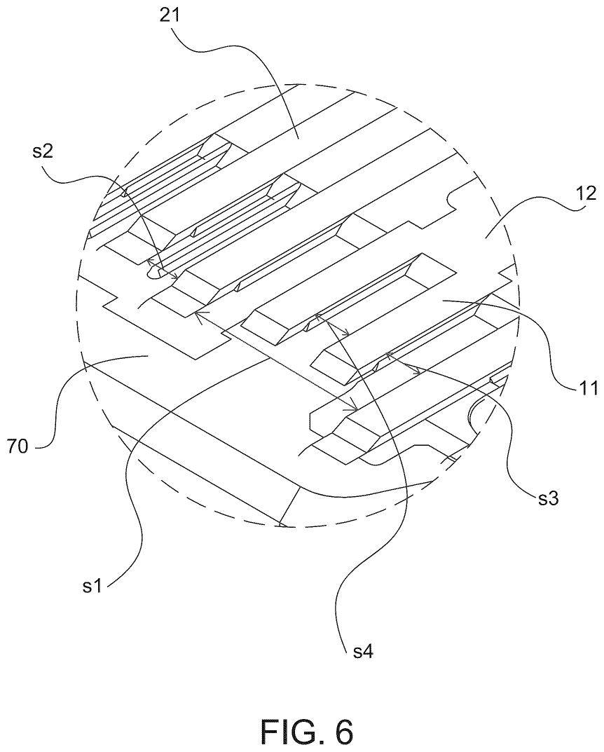

Referring to FIG. 5 and FIG. 6, the first spacing s1 and the second spacing s2 are formed at an outer side of each row of the connecting terminals 21. The first spacing s1 and the second spacing s2 are abreast disposed along the transverse direction. The first spacing s1 is formed between the outermost connecting terminal 21 and the middle connecting terminal 21 of each outer side of each row of the connecting terminals 21. The second spacing s2 is formed between the middle connecting terminal 21 and the innermost connecting terminal 21 of each outer side of each row of the connecting terminals 21. The first spacing s1 and the second spacing s2 are isolated by the middle connecting terminal 21.

Specifically, two outer adjacent connecting terminals 21 of each row of the connecting terminals 21 are spaced from each other to form the first spacing s1 between the two outer adjacent connecting terminals 21 of each row of the connecting terminals 21. The connecting terminal 21 which is closest to the inner connecting terminal 21 of the two outer adjacent connecting terminals 21 of each row of the connecting terminals 21 is spaced from the inner connecting terminal 21 of the two outer adjacent connecting terminals 21 of each row of the connecting terminals 21 to form the second spacing s2 between the connecting terminal 21 which is closest to the inner connecting terminal 21 of the two outer adjacent connecting terminals 21 of each row of the connecting terminals 21 and the inner connecting terminal 21 of the two outer adjacent connecting terminals 21 of each row of the connecting terminals 21.

Referring to FIG. 5 to FIG. 7, a leftmost side and a rightmost side of the upper portion of the terminal assembly 20 are defined as two outer sides of the upper portion of the terminal assembly 20. A leftmost side and a rightmost side of the lower portion of the terminal assembly 20 are defined as two outer sides of the lower portion of the terminal assembly 20. Each outer side of the upper portion of the terminal assembly 20 and the lower portion of the terminal assembly 20 has two adjacent connecting terminals 21. The two outer sides of the upper portion of the terminal assembly 20 have the two adjacent connecting terminals 21 which are positioned at the first pin position A1 and the fourth pin position A4, and the two adjacent connecting terminals 21 which are positioned at the ninth pin position A9 and the twelfth pin position A12. The connecting terminal 21 positioned at the first pin position A1 and the connecting terminal 21 positioned at the fourth pin position A4 of one outer side of the upper portion of the terminal assembly 20 are spaced from each other to form the first spacing s1 between the connecting terminal 21 positioned at the first pin position A1 and the connecting terminal 21 positioned at the fourth pin position A4 of the one outer side of the upper portion of the terminal assembly 20. The connecting terminal 21 positioned at the ninth pin position A9 and the connecting terminal 21 positioned at the twelfth pin position A12 of the other outer side of the upper portion of the terminal assembly 20 are spaced from each other to form the first spacing s1 between the connecting terminal 21 positioned at the ninth pin position A9 and the connecting terminal 21 positioned at the twelfth pin position A12 of the other outer side of the upper portion of the terminal assembly 20.

The two outer sides of the lower portion of the terminal assembly 20 have the two adjacent connecting terminals 21 which are positioned at the first terminal position B1 and the fourth terminal position B4, and the two adjacent connecting terminals 21 which are positioned at the ninth terminal position B9 and the twelfth terminal position B12. The connecting terminal 21 positioned at the ninth terminal position B9 and the connecting terminal 21 positioned at the twelfth terminal position B12 of one outer side of the lower portion of the terminal assembly 20 are spaced from each other to form the first spacing s1 between the connecting terminal 21 positioned at the ninth terminal position B9 and the connecting terminal 21 positioned at the twelfth terminal position B12 of the one outer side of the lower portion of the terminal assembly 20. The connecting terminal 21 positioned at the first terminal position B1 and the connecting terminal 21 positioned at the fourth terminal position B4 of the other outer side of the lower portion of the terminal assembly 20 are spaced from each other to form the first spacing s1 between the connecting terminal 21 positioned at the first terminal position B1 and the connecting terminal 21 positioned at the fourth terminal position B4 of the other outer side of the lower portion of the terminal assembly 20.

The inner connecting terminal 21 of the one outer side of the upper portion of the terminal assembly 20 is positioned at the fourth pin position A4. The connecting terminal 21 closest to the inner connecting terminal 21 of the one outer side of the upper portion of the terminal assembly 20 is positioned at the fifth pin position A5. The inner connecting terminal 21 of the other outer side of the upper portion of the terminal assembly 20 is positioned at the ninth pin position A9. The connecting terminal 21 closest to the inner connecting terminal 21 of the other outer side of the upper portion of the terminal assembly 20 is positioned at the eighth pin position A8. The connecting terminal 21 positioned at the fifth pin position A5 is spaced from the connecting terminal 21 positioned at the fourth pin position A4 to form a second spacing s2 between the connecting terminal 21 positioned at the fifth pin position A5 and the connecting terminal 21 positioned at the fourth pin position A4. The connecting terminal 21 positioned at the eighth pin position A8 is spaced from the connecting terminal 21 positioned at the ninth pin position A9 to form the second spacing s2 between the connecting terminal 21 positioned at the eighth pin position A8 and the connecting terminal 21 positioned at the ninth pin position A9.

The inner connecting terminal 21 of the one outer side of the lower portion of the terminal assembly 20 is positioned at the ninth terminal position B9. The connecting terminal 21 closest to the inner connecting terminal 21 of the one outer side of the lower portion of the terminal assembly 20 is positioned at the eighth terminal position B8. The inner connecting terminal 21 of the other side of the lower portion of the terminal assembly 20 is positioned at the fourth terminal position B4. The connecting terminal 21 closest to the inner connecting terminal 21 of the other side of the lower portion of the terminal assembly 20 is positioned at the fifth terminal position B5. The connecting terminal 21 positioned at the eighth terminal position B8 is spaced from the connecting terminal 21 positioned at the ninth terminal position B9 to form the second spacing s2 between the connecting terminal 21 positioned at the eighth terminal position B8 and the connecting terminal 21 positioned at the ninth terminal position B9. The connecting terminal 21 positioned at the fifth terminal position B5 is spaced from the connecting terminal 21 positioned at the fourth terminal position B4 to form the second spacing s2 between the connecting terminal 21 positioned at the fifth terminal position B5 and the connecting terminal 21 positioned at the fourth terminal position B4.

A width of the first spacing s1 is wider than a width of the second spacing s2. The plurality of the insulating dummy terminals 11 are disposed in the first spacing s1 of the electrical connector 100. Each two adjacent insulating dummy terminals 11 are located between the outermost connecting terminal 21 and the middle connecting terminal 21 of one outer side of one row of the connecting terminals 21.

An interval between an outer insulating dummy terminal 11 of each two adjacent insulating dummy terminals 11 and the connecting terminal 21 which is closest to the outer insulating dummy terminal 11 of the two adjacent insulating dummy terminals 11 is the same as an interval between an inner insulating dummy terminal 11 of each two adjacent insulating dummy terminals 11 and the connecting terminal 21 which is closest to the inner insulating dummy terminal 11 of the two adjacent insulating dummy terminals 11. Each insulating dummy terminal 11 is spaced from the connecting terminal 21 which is closest to the insulating dummy terminal 11 to form the third spacing s3 between the insulating dummy terminal 11 and the connecting terminal 21 which is closest to the insulating dummy terminal 11. Each two adjacent insulating dummy terminals 11 connected with the same collecting portion 12 are spaced from each other to form the fourth spacing s4. The width of the second spacing s2, a width of the third spacing s3 and a width of the fourth spacing s4 are the same.

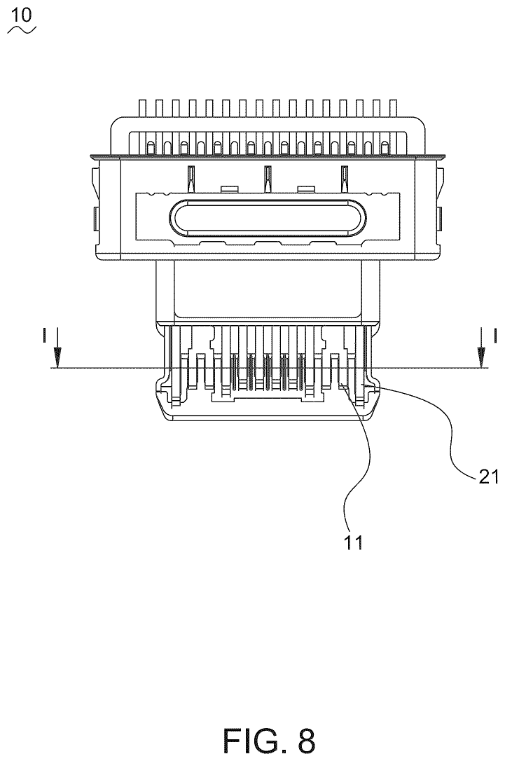

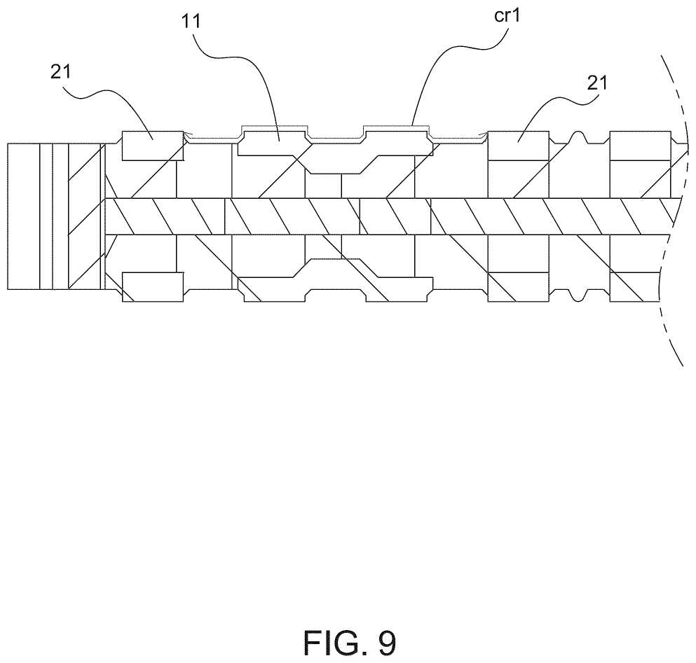

Referring to FIG. 5 to FIG. 9, When sweat infiltrates into the electrical connector 100 according to the present invention, the insulating dummy terminals 11 disposed in the first spacing s1 elongate a path cr1 along an insulating surface of the tongue assembly 10, and a creepage distance of the electrical connector 100 is elongated, so an electric field between the two adjacent connecting terminals 21 located to two sides of each first spacing s1 is weakened. When the two adjacent connecting terminals 21 located to the two sides of each first spacing s1 are powered on, the tongue assembly 10 is prevented from being polarized to restrain electrochemical reactions, a corrosion phenomenon occurrence is reduced, and less corrosive substances are caused to be accumulated on a surface of the front end of the tongue assembly 10.

As described above, the electrical connector 100 dispose the plurality of the insulating dummy terminals 11 at the terminal missing positions of the tongue assembly 10, corrosions caused by the electrochemical reactions are reduced when the sweat infiltrates into the electrical connector 100. Furthermore, the plurality of the insulating dummy terminals 11 are protruded from the surface of the insulating base 70, and dimensions of the plurality of the insulating dummy terminals 11 are approximately the same as dimensions of the plurality of the connecting terminals 21. In addition, the interval between the outer insulating dummy terminal 11 of each two adjacent insulating dummy terminals 11 and the connecting terminal 21 which is closest to the outer insulating dummy terminal 11 of the two adjacent insulating dummy terminals 11 is the same as the interval between the inner insulating dummy terminal 11 of each two adjacent insulating dummy terminals 11 and the connecting terminal 21 which is closest to the inner insulating dummy terminal 11 of the two adjacent insulating dummy terminals 11, so the insulating dummy terminals 11 disposed in the first spacing s1 elongate the path crl along the insulating surface of the tongue assembly 10 of the electrical connector 100, and when the two adjacent connecting terminals 21 located to the two sides of each first spacing s1 are provided electric current, an electric field intensity between the two adjacent connecting terminals 21 is reduced. As a result, the electrical connector 100 has a structure that reduces a corrosion production when the sweat infiltrates into the electrical connector 100, and a corrosion resistance performance of the electrical connector 100 is ultimately improved.

Though the present invention is disclosed as the above-mentioned embodiment, the embodiment disclosed in this invention is without being intended to limit a scope of this invention. In related technical fields, anyone with ordinary knowledges should be able to make a few changes and embellishments within a spirit and a protection scope of this invention, so the protection scope of this invention should regard defined claims of an attached application patent as a standard.

What is claimed is:

1. An electrical connector, comprising:
an insulating base;
a terminal assembly mounted in the insulating base, the terminal assembly having a plurality of connecting terminals, a first spacing and a second spacing, the plurality of the connecting terminals being fixed in the insulating base, the plurality of the connecting terminals being arranged in two rows, each row of the connecting terminals being arranged along a transverse direction, the two rows of the connecting terminals being arranged along an up-down direction, the first spacing and the second spacing being formed at an outer side of each row of the connecting terminals, the first spacing and the second spacing being abreast disposed along the transverse direction, a width of the first spacing being wider than a width of the second spacing;
a plurality of insulating dummy terminals, the plurality of the insulating dummy terminals being spaced from one another, the plurality of the insulating dummy terminals being disposed in the first spacing, rear ends of each two adjacent insulating dummy terminals extending rearward and then being merged with each other to form a collecting portion extending rearward, each two adjacent insulating dummy terminals and the collecting portion which is connected to the rear ends of the two adjacent insulating dummy terminals being shown as an inverted Y shape;
wherein docking surfaces of the plurality of the insulating dummy terminals and docking surfaces of the plurality of the connecting terminals are coplanar.

2. The electrical connector as claimed in claim 1, wherein the plurality of the insulating dummy terminals are protruded from a surface of the insulating base.

3. The electrical connector as claimed in claim 1, wherein each two adjacent insulating dummy terminals are located between the outermost connecting terminal and a middle connecting terminal of one outer side of one row of the connecting terminals.

4. The electrical connector as claimed in claim 1, wherein the first spacing and the second spacing are isolated by a middle connecting terminal.

5. The electrical connector as claimed in claim 1, wherein top surfaces of the plurality of the insulating dummy terminals are defined as the docking surfaces of the plurality of the insulating dummy terminals, and top surfaces of the plurality of the connecting terminals are defined as the docking surfaces of the plurality of the connecting terminals.

6. The electrical connector as claimed in claim 1, wherein the first spacing is formed between the outermost connecting terminal and a middle connecting terminal of each outer side of each row of the connecting terminals.

7. The electrical connector as claimed in claim 1, wherein the second spacing is formed between a middle connecting terminal and the innermost connecting terminal of each outer side of each row of the connecting terminals.

8. The electrical connector as claimed in claim 1, wherein each insulating dummy terminal is spaced from the connecting terminal which is closest to the insulating dummy terminal to form a third spacing between the insulating dummy terminal and the connecting terminal which is closest to the insulating dummy terminal.

9. The electrical connector as claimed in claim 8, wherein each two adjacent insulating dummy terminals connected with the same collecting portion are spaced from each other to form a fourth spacing.

10. The electrical connector as claimed in claim 9, wherein the width of the second spacing, a width of the third spacing and a width of the fourth spacing are the same.

11. An electrical connector, comprising:
an insulating base;
a terminal assembly mounted in the insulating base, the terminal assembly having a plurality of connecting terminals, a first spacing and a second spacing, the plurality of the connecting terminals being fixed in the insulating base, the plurality of the connecting terminals being arranged in two rows, each row of the connecting terminals being arranged along a transverse direction, the two rows of the connecting terminals being arranged along an up-down direction, the first spacing and the second spacing being formed at an outer side of each row of the connecting terminals, the first spacing and the second spacing being abreast disposed along the transverse direction, a width of the first spacing being wider than a width of the second spacing;
a plurality of insulating dummy terminals disposed at terminal missing positions, the plurality of the insulating dummy terminals being disposed in the first spacing, rear ends of each two adjacent insulating dummy terminals extending rearward and then being merged with each other to form a collecting portion extending rearward, an interval between an outer insulating dummy terminal of each two adjacent insulating dummy terminals and the connecting terminal which is closest to the outer insulating dummy terminal of the two adjacent insulating dummy terminals being the same as an interval between an inner insulating dummy terminal of each two adjacent insulating dummy terminals and the connecting terminal which is closest to the inner insulating dummy terminal of the two adjacent insulating dummy terminals;
wherein docking surfaces of the plurality of the insulating dummy terminals and docking surfaces of the plurality of the connecting terminals are coplanar.

12. The electrical connector as claimed in claim 11, wherein each two adjacent insulating dummy terminals and the collecting portion which is connected to the rear ends of the two adjacent insulating dummy terminals are shown as an inverted Y shape.

13. An electrical connector, comprising:
an insulating base;
a terminal assembly mounted in the insulating base, the terminal assembly having a plurality of connecting terminals, a first spacing and a second spacing, the plurality of the connecting terminals being fixed in the insulating base, the plurality of the connecting terminals being arranged in two rows, each row of the connecting terminals being arranged along a transverse direction, the two rows of the connecting terminals being arranged along an up-down direction, the first spacing and the second spacing being formed at an outer side of each row of the connecting terminals, the first spacing being formed between the outermost connecting terminal and a middle connecting terminal of each outer side of each row of the connecting terminals, the second spacing being formed between the middle connecting terminal and an innermost connecting terminal of each outer side of each row of the connecting terminals, the first spacing and the second spacing being abreast disposed along the transverse direction, a width of the first spacing being wider than a width of the second spacing;
a plurality of insulating dummy terminals protruded from a surface of the insulating base, the plurality of the insulating dummy terminals being disposed in the first spacing, rear ends of each two adjacent insulating dummy terminals extending rearward and then being merged with each other to form a collecting portion extending rearward;
wherein docking surfaces of the plurality of the insulating dummy terminals and docking surfaces of the plurality of the connecting terminals are coplanar.
